(19) United States
(12) Patent Application Publication
(10) Pub. No.: US 2016/0321736 A1
(43) Pub. Date: Nov. 3, 2016

(54) A METHOD FOR PROVIDING A RECOMMENDATION AND A RECOMMENDATION APPARATUS

(71) Applicant: Quanox S.A.R.L, Luxembourg (LU)

(72) Inventor: SØREN Vang ANDERSEN, Esch-sur-Alzette (LU)

(73) Assignee: Quanox S.A.R.L, Luxemburg (LU)

(21) Appl. No.: 15/111,413

(22) PCT Filed: Jun. 24, 2014
(86) PCT No.: PCT/EP2014/063273

§ 371 Date: Jul. 13, 2016

(30) Foreign Application Priority Data
Jan. 21, 2014 (EP) 14151878.7

(51) Int. Cl. G06Q 30/06; G06F 17/30

(52) U.S. Cl. CPC G06Q 30/0631; G06F 17/30601

(57) ABSTRACT

This disclosure relates to a method for providing a recommendation to a recipient. The method comprises obtaining input data, and applying a first mapping to the input data to produce a first primary data representation. The first mapping is a non-bijective mapping. The method comprises providing the first primary data representation and obtaining a second data representation based on the first primary data representation. The method comprises determining recommendation data for the recipient based on the second data representation, and outputting the recommendation data to the recipient.

### TECHNICAL FIELD

The present disclosure relates to the field of recommendation systems, and more specifically to a method for providing a recommendation and a recommendation apparatus.

### BACKGROUND

Recommendation systems for providing recommendations of items to users have attracted much attention in the recent years in both research and industry. The potentials to more effectively exposing customers to parts of an extensive inventory that suits their preferences and the consequent improved user experience have motivated interest in recommendation systems, especially when dealing with e-commerce and media services.

Today, existing solutions for recommendation systems are based on a single mapping (comprising a collaborative filter such as a low-rank mapping) between users and items, providing estimates based on e.g. the estimated rating for user u of item i, a trained bias element for that, and personalization factors for user u and property factors for item i. Typical dimensions of such mappings are in the range of millions of users, and thousands of items. Dimensions of personalization factors and property factors in the range of hundreds have empirically shown to saturate the modelling capacity of such a model on typical datasets.

Another issue with these models or systems is the lack of robustness against unbalanced datasets, where some parts of the dataset has very sparse data and other parts have more dense data. Existing solutions provide ineffective modelling, handling, and/or processing of unbalanced data.

Furthermore, recommendation systems are required to adapt to changes in user preferences. Various methods for introducing dynamic adaptation in the low-rank personalization models have been proposed. Attempts to dynamic adaption of recommendation methods require even more complete data representation, which aggravates the problem with unbalanced data. Therefore, the existing solutions provide ineffective adaptation of the modelling or the recommender system to changes in preferences of users.

Finally, a broadly acknowledged problem with existing methods is their inability to provide diversity in the recommended items. Typically, recommender systems are reasonably good at recommending items that are generally popular or items that are tightly related but less good at recommending relevant items that do not show these types of relations.

Hence, the existing solutions present problems with unbalancedness, and inefficiencies in terms of adaptivity, and diversity.

### SUMMARY

It is an object of the present disclosure to provide an improved method for providing recommendation to a recipient.

According to the present disclosure, a method for providing a recommendation to a recipient is provided. The method comprises obtaining input data, and applying a first mapping to the input data to produce a first primary data representation. The first mapping is a non-bijective mapping. The method comprises providing the first primary data representation and obtaining a second data representation based on the first primary data representation. The method comprises determining recommendation data for the recipient based on the second data representation, and outputting the recommendation data to the recipient.

Also disclosed is a method performed in a recommendation apparatus for providing an element of recommendation to a recipient. The recommendation apparatus comprises an interface and one or more processors. The method comprises obtaining input data in form of one or more tuples via the interface; using the one or more processors to apply a first mapping to the input data to produce a first primary data representation, the first mapping being a non-bijective mapping, the first primary data representation identifying a cluster or a state based on the one or more tuples; and providing the first primary data representation. The method comprises using the one or more processors to obtain a second data representation based on the first primary data representation, the second data representation being indicative of a set of elements with associated estimates. The method comprises using the one or more processors to determine recommendation data for the recipient based on the second data representation, the recommendation data comprising the element of recommendation. The method comprises outputting the recommendation data to the recipient via the interface.

Also disclosed is a recommendation apparatus. The recommendation apparatus comprises: an interface for receiving input data, the input data being in form of one or more tuples; one or more processors having an input connected to the interface; and a storage unit for storing input data. The one or more processors are configured to apply a first mapping of the input data to produce a first primary data representation. The first mapping is a non-bijective mapping. The first primary data representation identifies a cluster or a state based on the one or more tuples. The one or more processors are configured to obtain a second data representation based on the first primary data representation, the second data representation being indicative of a set of elements with associated estimates. The apparatus is configured to determine recommendation data based on the second data representation, the recommendation data comprising the element of recommendation. The apparatus is configured to output the recommendation data.

The method may comprise applying a second mapping to the provided first primary data representation to produce the second data representation; and providing the second data representation.

The second mapping may comprise collaborative filtering.

Further, this disclosure relates to a recommendation apparatus. The recommendation apparatus comprises an interface for receiving input data; one or more processors having an input connected to the interface; and a storage unit for storing input data. The one or more processors are configured to apply a first mapping of the input data to produce a first primary data representation. The one or more processors are configured to obtain a second data representation based on the first primary data representation. The first mapping is a non-bijective mapping. The apparatus is configured to determine recommendation data based on the second data representation and to output the recommendation data.

The present disclosure seeks to solve, or to partially solve, a set of problems relating to recommendations systems in general such as performing based on unbalanced data, while adapting the recommendations to changing characteristics; and providing a recommendation that is diverse.

It is an advantage of the present disclosure that resources of a recommendation apparatus or a computer such as memory, processing power are more optimally used. For example, elements of recommendation are often selected from a large input data set, typically containing millions of elements. This disclosure allows filtering, or compressing the input data and storing a first primary data representation that requires less memory and allows faster further processing towards determining an element of recommendation.

It is an advantage of the present disclosure that it effectively handles unbalanced data. The present disclosure allows handling input data that may have much associated information as well as input data that may have less associated information. For a dense input data set, the first mapping effectively splits such data into two or more first primary data representations, which allows the second mapping to provide more refined modelling or recommendation data. For input data with less associated information, the first mapping maps the input data to a first primary data representation that other input data has been mapped to, and thus such data gets a more robust modelling, processing or handling through the second mapping. The disclosure provides recommendation upon elements of different nature such as different media types, where unbalancedness is aggravated.

It is a further advantage of the present disclosure that faster adaptation to changing characteristics of input data is provided for. This results in an optimized processing of the changing input data. This disclosure provides a dynamic modelling and tracking which is configured to be adaptive on few data, without compromising the long-term training and precision of the second mapping. This advantage is further emphasized through the proactive dynamic tracking enabled by applications of the first mapping.

Additionally, the present disclosure provides diversity in recommendation data. Diversity involves linking data representations that may not otherwise be linked for a user if the data representations were based solely on the input data for that user. The second mapping is performed for each of the first primary data representations and an output of the second mapping is acquired in a collaborative manner. The present disclosure provides a dynamic tracking of changing allocations of input data to each of the first primary data representations and a proactive first mapping. Both the dynamic tracking and the proactive effect of the disclosure enable adaptivity and diversity in the recommendation data.

In one or more exemplary methods, the first mapping and/or the second mapping may be optimized using sparse optimization. Each of the above advantages may be strengthened by the more effective usage of sparse optimization within the method, altogether extending the effective operation of this disclosure, and extending the effective operation of sparse optimization within the method.

This disclosure relates to a computer program, comprising computer readable code which, when run on a processing unit causes the apparatus to perform the method as described above. The present disclosure provides a more accurate adaptation to changing input data.

The above and other features and advantages of the present invention will become more apparent to those of ordinary skill in the art by describing in detail exemplary embodiments thereof with reference to the attached drawings in which:

### BRIEF DESCRIPTION OF THE DRAWINGS

FIG. 1 is a flow-chart illustrating an exemplary method for providing a recommendation to a recipient according to this disclosure.

FIG. 2 is a flow-chart illustrating an exemplary method for providing a recommendation to a recipient, including determining a trendsetter, according to this disclosure,

FIG. 3 illustrates a block diagram of an exemplary recommendation apparatus according to the present disclosure,

FIG. 4 illustrates a block diagram of an exemplary structure for the method according to the present disclosure,

FIG. 5 illustrates a block diagram of an exemplary second mapping of the method according to this disclosure,

FIG. 6 illustrates a block diagram of an exemplary first mapping of the method according to this disclosure,

### DETAILED DESCRIPTION OF THE DRAWINGS

The present invention will now be described more fully hereinafter with reference to the accompanying drawings, in which exemplary embodiments of the invention are shown. The invention may, however, be embodied in different forms and should not be construed as limited to the examples set forth herein. Rather, these examples are provided so that this disclosure will be thorough and complete, and will fully convey the scope of the disclosure to those skilled in the art.

As used herein, the term “recipient” refers to an entity that receives the output of the method and apparatus disclosed herein. The recipient is the entity that is provided with recommendation data outputted by the method and apparatus disclosed herein. The recipient may be part of a system running the method or comprising the recommendation apparatus. The recipient may be external to a system running the method or comprising the recommendation apparatus. The recipient is a sink of the recommendation data. The recipient may be a user, an end user such as a human being, for whom the recommendation is rendered through a user-interface. The recipient may be a consumer of the recommendation. The recipient may be a system which may in turn use the delivered recommendation for whichever purpose that fits the purpose of such system, including rendering such recommendations to an end user. The recipient as a system may further process the output from the method and apparatus disclosed herein before providing a recommendation to an end user, or may directly forward to an end user the recommendation outputted by the method and apparatus disclosed herein. The recipient may be a service provider interfacing an input provider. The recipient may be a service provider interfacing an end user, which is then the final recipient of the recommendation. The recipient may be a website.

The recipient of recommendation data provided by the method and apparatus disclosed herein may be an ad-serving engine that may apply a recommendation outputted by the method and apparatus disclosed herein as a support to a decision on the placement and/or rendering of an advertisement on a web-site. The recipient may be a marketing entity.

As used herein, the term “recommendation” refers to a suggestion to a recipient. A recommendation may aim at matching a characteristic of the recipient. A recommendation may aim at satisfying the recipient or at raising interest of the recipient. A recommendation is regarding an element on which a suggestion is made.

As used herein, the term “element” refers to the object of the recommendation. An element is e.g. an item, a website, a service, a market, a consumer, a consumer segment, an advertisement, a communication channel for an advertisement, or any combination thereof. An item may refer to a physical object, or a thing having material existence. The item may be an article, a product, a media (e.g. text, audio, and/or video), and/or a digital item. A recommendation may be in form of a set of links recommended to a recipient.

As used herein, the term “input data” refers to data provided as input to the method and apparatus disclosed herein. The input data may be related to a user, such as an individual, or a group of individuals. The input data may be related to an item, a website, a service, a market, a consumer, a consumer segment, an advertisement, a communication channel for an advertisement, or any combination thereof. The input data may be a preference, a set of preferences and/or behaviour of a user. The input data may be a preference and/or rating, a set of preferences and/or rating related to an item, a website, a service, a market, a consumer, a consumer segment, an advertisement, a communication channel for an advertisement, or any combination thereof. The input data may be given directly by an input provider or inferred based on information collected from the input provider. The input data may relate to a set of related web pages served from a single web domain, such as a website. The input data may relate to an advertising material such as an advertisement. The input data may relate to a query, such as a keyword or a search query. The input data may be related to an item, a product or a service, such as features, characteristics or properties of the item, product, or service.

As used herein, the term “input data provider” refers to an entity providing input data to the method and apparatus disclosed herein. The input provider may be a source of the input data, or an intermediate entity between the source of the input data and a recommendation apparatus. The input provider may be a system, a user, or an end user such as a human being. The input provider may be a recipient of a recommendation generated by the method disclosed herein. The input provider may be a website. The input provider may be a radio, television, text or any other media service, such as a real-time service, a streaming service, and/or an on-demand media service. The input provider may be a service provider interfacing an input provider.

The method and apparatus of this disclosure provide recommendation data to a recipient. For example, the method disclosed herein may recommend items to users, where items can typically be media such as audio video or text, physical items for sale, or web-links to follow. For example, the disclosure may take input data relating to a web site and may output recommendation on an advertisement to render on the website, or vice versa. Input data may also be related to users while output of the disclosed method provides a web link for the user to follow. For input data as a query, output of the method and apparatus disclosed herein may be e.g. advertisements to render and links to follow. In exemplary scenario, input data may be related to a product or a service and output of the disclosed method is a customer or a market to market such product or service to. Additionally, input data may be an advertisement and output of the disclosed method is e.g. a communication channel to place the advertisement in, such as a web site or a TV channel or a radio show or a publication.

The method disclosed herein is for providing a recommendation to a recipient. The method comprises obtaining input data. Input data may be obtained from an input provider and/or may be derived from a set of observations of actions performed by an input provider or an end user connected to the input provider. Input data may be retrieved from a data storage unit. Alternatively or additionally, input data may be provided online by an input provider.

The method comprises applying a first mapping to the input data to produce a first primary data representation. The first mapping may be a relation between an argument and a permissible image. The first mapping may be a relation between elements of two sets.

The first mapping is a non-bijective mapping. The first mapping when seen as a point-by-point mapping is not bijective. A bijective mapping requires every element of a first set to be mapped to exactly one element of a second set, and every element of the second set to be mapped to exactly one element of the first set. In other mathematical terms, a bijective mapping f: X→Y is a one to one and onto mapping of a set X to a set Y.

A non-bijective mapping is either not a one-to-one mapping, or not an onto mapping, or a not-one-to-one and not-onto mapping. In other words, a non-bijective mapping may be defined as a non-injective mapping, or a non-surjective mapping, or a non-injective and non-surjective mapping. A characteristic of a non-bijective mapping is that it is non-invertible. The non-bijective mapping may be a one-way function, in which different input data X1, X2 may have the same output Y.

The non-bijective property of the first mapping may result in the first primary data representation not being linkable to exactly one input data. There may exist at least one first primary data representation that cannot in isolation be inverted into a single unique input data. Additionally or alternatively, there may exist at least one input data which cannot in isolation be mapped to a single first primary data representation. Rather the first mapping may result in two or more first primary data representations. The non-bijective property of the first mapping may be seen as introducing a loss of information for a given input data. However, the non-bijective property of the first mapping enables the method according to this disclosure to provide mitigation to the above listed problems.

The first mapping may thus serve to group input data into one or more first primary data representations with e.g. shared characteristics, patterns or traits.

The method comprises providing the first primary data representation. The first primary data representation may be defined as a representation indicative of the input data according to a characteristic of the input data. The first primary data representation is produced by the first mapping and provided to e.g. a second mapping, such as a collaborative filter.

The method comprises obtaining a second data representation based on the first primary data representation. The second data representation may be different from the first data representation. The second data representation may be a representation indicative of a set of elements, as defined above, with associated estimates. The second data representation is e.g. a representation of a set of items with associated estimated ratings. The second data representation may be a representation of a set of elements with associated probability of preference for a given first primary data representation. The second data representation is for example obtained by a second mapping applied to the first primary data representation.

The method comprises determining recommendation data for the recipient based on the second data representation. The recommendation data is determined based on the second data representation, which results from a manipulation of the first primary data representation. The recommendation data may be a sub-set of elements selected in the second data representation, such as a sub-set of items that are to be recommended to the recipient. In other words, the second data representation may be in this step finely tuned into recommendation data that provides elements of recommendation targeted to better match a characteristic of the recipient. The method may comprise determining one or more recommendation data for respective recipients based on one or more second data representations.

The method proceeds to outputting the recommendation data to the recipient. Outputting the recommendation data to the recipient may comprise providing the recommendation data to a recipient system that may process it further and/or present it to the end user. The method may comprise outputting one or more recommendation data to respective recipients.

The method may further comprise applying a second mapping to the provided first primary data representation to produce the second data representation; and providing the second data representation. The second mapping may be a relation between an argument and a permissible image. The second mapping may be a relation between elements of two sets. The second mapping is a relation between a first primary data representation of first primary data representation set and a second data representation of second data representation set. The second mapping may comprise collaborative filtering. The second mapping may comprise or be a method for collaborative filtering, such as a low-rank personalization model, a probabilistic latent semantic model, a Markov model, a neighborhood-based model, a regression-based latent factor model, a hypergraph method or any combination thereof. The second mapping may comprise input characterizing coefficients, a set of output characterizing functions, and an aggregation function.

The present disclosure presents training operations of the method disclosed herein. Training (e.g. offline training) refers to exercising the method, and underlying first and second mapping based on input data stored, such as historic data, prior to and/or after, and/or during a provisioning of a recommendation. After an offline training of the method, the input data used to train the method as well as the resulting first data representation and second data representation may be stored and used for providing a recommendation during an online operation of the disclosed method.

In an illustrative example of where the proposed technique is applicable, it is assumed that input data is obtained in the form of tuples <u,i,t,r> where u identifies an actor, such as a user or an input provider, and i identifies the element acted upon such as a media item or a product, t is the time of the action and r identifies what was observed about the action. In this context, r may generally be a rating, a behaviour, an action (such as inspecting, choosing, or rejecting), a property related to the tuple, or any combination thereof. The input data tuples are e.g. used to train the parameters involved in the method disclosed or the recommendation apparatus in operations that may include offline training operations and/or calculations during an online recommendation operation.

A request for recommendation handled by this disclosure is in this example denoted by a shorter input data tuple <u>. The shorter input data tuple is given as input to the first mapping to obtain a first primary data representation <s>. The first primary data representation <s> may identify a cluster or a state that u is believed to be part of based on previously received <u,i,t,r> tuples. The first mapping is designed such that users that are mapped to a certain <s> shares common traits in their <u,i,t,r> input data. A second mapping for <s> is then used according to this disclosure to obtain a second data representation for <s>. The second data representation for <s> is a set of elements, such as items, with associated estimates for r, or probabilities of r happening: <<si₁,psi₁>, <si₂,psi₂>, <si_{L},psi_{L}>> based on which recommendation data can be determined and output to the recipient. The recipient may be the user giving the input data. The recommendation may be an ordered list of items <siₙ> for which high estimates or probabilities <psiₙ> are obtained in the disclosed method. By the purpose of the first mapping to group together input data that shares common traits, the first primary data representation <s> in general becomes insufficient information to invert back to a unique <u>. In other words, the first mapping applied to <u> is non-bijective.

The method may comprise applying the second mapping to a plurality of first primary data representations. Applying the second mapping to a plurality of first primary data representations may produce one or more second data representations for one or more recipients.

Applying the first mapping may comprise producing a first secondary data representation. Determining recommendation data for the recipient based on the second data representation may comprise applying a third mapping to the first secondary data representation and the second data representation. The third mapping may be a relation between an argument and a permissible image. The third mapping may be a relation between elements of two sets. The third mapping is a relation that takes as input a first secondary data representation and a second data representation and that outputs a recommendation data. The third mapping allows for a recommendation data optimized for the recipient, and eventually for a recommendation data that optimally matches an interest of the recipient.

The first mapping may comprise a clustering method and/or a Markov chain. The clustering method may comprise a fuzzy clustering method, and/or a self-organized clustering method. The self-organized clustering method may comprise a k-means clustering method and/or a self-organized Kohonen map.

In an exemplary method where the first mapping comprises a clustering method, applying the first mapping produces a cluster identifier as a first primary data representation and may additionally produce a cluster membership function as a first secondary data representation.

In another exemplary method, the fuzzy clustering method used as first mapping can effectively balance the sparseness of the clusters through a splitting and pruning process: clusters for which there is much combined input data are split and clusters for which there is few combined input data are pruned during the offline training operation. The proposed exemplary method thereby accomplishes a first mapping explicitly designed to improve performance on unbalanced data.

The first primary data representation may comprise an identifier of one or more states including a first state in a Markov chain and the first secondary data representation comprises one or more state probabilities including a state probability of the first state and the second data representation comprises an emission probability related to the first primary data representation.

In one or more exemplary methods, the method is divided into an online recommendation operation with the purpose to effectively obtaining recommendations for new input data, and an offline training operation in which parameters may be trained with a basis in historic input data that has been stored in a database. Which parts of the method operations are accomplished during offline training operation and which parts of the disclosed method operations are subsequently accomplished during online recommendation depend on the specific type of second mapping, e.g. the type of collaborative filter. The offline-online balance in the disclosed method depends as well on implementation considerations relating to the amount of historic input data, the size of the fundamental matrix completion problem (e.g. the total number of users times the total number of elements for recommendation) that is anticipated in the specific intended usage of the method, and further considerations relating to cost of storage versus cost of computations during online operation. The present disclosure is not affected by whether specific parts of the method are accomplished during offline training operation and stored for later usage during online recommendation operation or accomplished directly during online recommendation operation.

In one or more exemplary methods, the second mapping may be a means of calculating probabilities for outputs relating to each of the clusters found by the first mapping. Additionally, the second mapping may generate probabilities that are found in a collaborative manner between clusters rather than for each cluster observed in isolation. Hereby probabilities can be estimated even for output observations that have not yet been observed from a cluster, which provides diverse recommendations.

The second mapping may comprise a second primary mapping parameter. The second primary mapping parameter may be representative of the first primary data representation. The second primary mapping parameter may be the first primary data representation. For example, if the first mapping comprises a Markov chain model, the second primary mapping parameter may be an identifier of a Markov state. For example, if the first mapping is a clustering method, the second primary mapping parameter may be an identifier of a cluster.

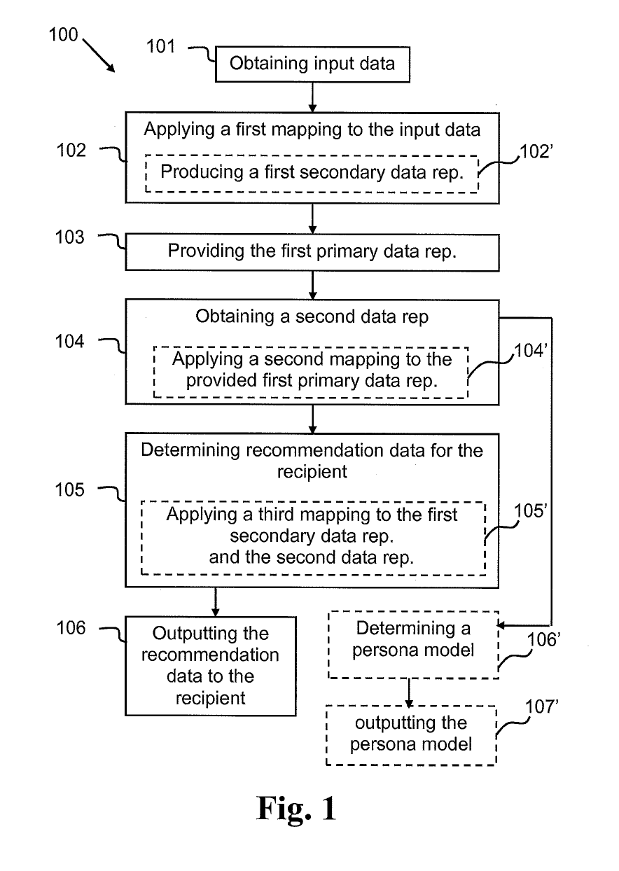

FIG. 1 shows a flow-chart illustrating an exemplary method 100 for providing a recommendation to a recipient. The method 100 for providing a recommendation to a recipient comprises obtaining 101 input data. Obtaining 101 input data may comprise obtaining input data from an input provider, or deriving input data from a set of observations or actions performed by an input provider. Obtaining 101 input data may involve obtaining input data online directly from an input provider. Alternatively or additionally, obtaining 101 input data may comprise retrieving input data from a data storage unit.

The method 100 comprises applying 102 a first mapping to the input data to produce a first primary data representation. The first mapping is a non-bijective mapping. Applying 102 a first mapping to the input data to produce a first primary data representation may comprise applying a relation between elements of an input data set and elements of a first primary data representation set. The non-bijective first mapping may be a non-injective mapping, in which different input data X1, X2, may have e.g. the same first primary data representation. Applying 102 a first mapping may serve to group or re-group input data into a first primary data representation with e.g. shared characteristics, patterns or traits. Applying 102 a first mapping to the input data may comprise producing 102′ a first secondary data representation. The first primary data representation is related to the first secondary data representation but the first primary data representation is different from the first secondary data representation. For example, if the first mapping comprises a Markov chain, the first primary data representation may comprise an identifier of one or more states including a first state and the first secondary data representation may comprise a state probability of the first state.

The method 100 comprises providing 103 the first primary data representation. Providing 103 the first primary data representation may comprise providing the first primary data representation to a second mapping, such as a collaborative filter. Providing 103 the first primary data representation may involve providing the first primary data representation to an internal processor of a recommendation apparatus or to a processor external to the recommendation apparatus for further applications.

The method 100 comprises obtaining 104 a second data representation based on the first primary data representation. Obtaining 104 a second data representation may comprise obtaining 104 a data representation indicative of a set of elements of recommendation, as defined above, with associated estimates. Obtaining 104 a second data representation involves e.g. obtaining a representation of a set of items with associated ratings. Obtaining 104 a second data representation may comprise applying 104′ a second mapping to the produced first primary data representation. The second mapping may comprise collaborative filtering. Collaborative filtering may be defined as a process comprising filtering for information or patterns using techniques involving collaboration among a plurality of input providers. Collaborative filtering comprises a method of making estimates about a characteristic of an input provider (e.g. preferences or behaviours of a user) by collecting input data related to the characteristic from the one or more input providers. Applying collaborative filtering as a second mapping 104′ may result in providing a set of elements of recommendation with associated probabilities of each element suiting a recipient's purpose. Applying 104′ the second mapping to a plurality of first primary data representations may comprise applying the second mapping to a plurality of first primary data representations. Applying 104′ the second mapping to a plurality of first primary data representations may produce one or more second data representations, that may be relating to the same or different or intersecting sets of elements of recommendation.

The method 100 comprises determining 105 recommendation data for the recipient based on the second data representation. Determining 105 recommendation data may involve determining a sub-set of elements (e.g. a sub-set of items that are to be recommended to the recipient) based on estimates on the likelihood of the elements to match a characteristic of the recipient in a situation, wherein the sub-set of elements and the associated estimates are provided in the second data representation. Determining 105 recommendation data may comprise applying 105′ a third mapping to the first secondary data representation and the second data representation. Determining 105 recommendation data may be additionally based on a first secondary data representation that weights on the estimates provided in the second data representation. In other words, the step of determining 105 recommendation data for the recipient based on the second data representation may involve adjusting the second data representation with a first secondary data representation and selecting elements provided in the adjusted second data representation in order to generate a recommendation data that provides elements of recommendation targeted to better match a characteristic of the recipient (captured by the first primary data representation). The method 100 may comprise determining one or more recommendation data for respective recipients based on one or more second data representations.

The method 100 comprises outputting 106 the recommendation data to the recipient. Outputting 106 the recommendation data may be to a recipient system that may process it further and/or present it to the end user. Step 106 may comprise outputting one or more recommendation data to respective recipients. Outputting 106 the recommendation data may involve output data indexing elements of recommendation.

In one or more exemplary methods, the method 100 comprises determining 106′ a persona model based on the first primary data representation and the second data representation, and outputting 107′ the persona model. A persona model may characterize a group of users in a context, and may comprise an element of recommendation that may be relevant in that context. The persona model may be defined as a model of user behaviour or preference condensed into a situation. A persona model may comprise a model for a set of preferences and/or behaviours and/or ratings of users that they may adhere to in certain situations or when needing or desiring or searching for a certain kind of experience or product or information. And, several users may, depending on which situation they are in or which needs or desires they have, “take on different masks”, i.e. choose to become deterministically allocated to different persona. Simultaneously, several users, i.e. hundreds or thousands or millions of users, can with their situational and specific desire or need-dependent preferences and behaviours be simultaneously collaborating to the building of several persona models simultaneously. The persona model may be used e.g. for market analysis. The method 100 may further comprise obtaining a request for a persona model, and outputting the persona model.

In the disclosed method, a persona model may be characterized by a first primary data representation, one or more associated input characterizing coefficients, and ultimately one or more associated recommendations.

In one or more exemplary methods and apparatus, applying a second mapping may comprise applying a low-rank personalization model and/or a probabilistic latent factor model. Applying a low-rank personalization model and/or a probabilistic latent factor model in the second mapping may by virtue of the first mapping jointly capture a weighted set of the factors into one vector for each first primary data representation rather than for each individual input provider. A persona model may be represented by a first primary data representation, input characterizing coefficients related to the first primary data representation, a second data representation, and/or a recommendation data. A persona model may comprise a model of an input provider when acting according to a certain state or cluster in the first mapping.

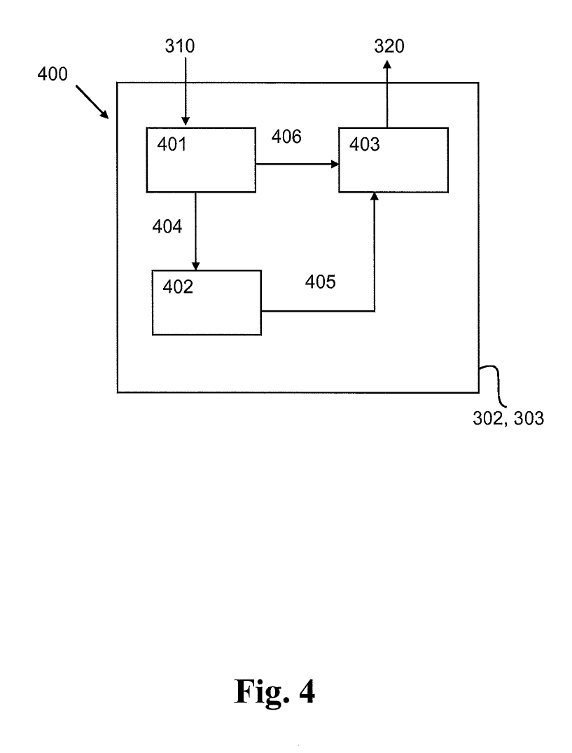

In an illustrative example where the proposed technique is applicable, it is assumed that input data relates to users and output data are recommendations of items. With reference to FIG. 4, the information passed as the first primary data representation 404 is considered information relating to a persona model, i.e. an index based on which the second mapping 402 can fetch or calculate the parameters characterising the persona model. Parameters characterising the personal model are e.g. the input characterizing coefficients 4040, 4041, through 4045, to 4049 relevant for that particular persona model. During online recommendation operation, the first mapping 401 calculates e.g. the dynamically changing probabilities of each of the persona models (seen as Markov states) being currently active in the user preferences or behaviour and passes each of them (or a top-M most likely part of them) to the second mapping 402. The third mapping 403 weights the output 405 with their estimated probabilities of being active which is obtained as the first secondary data representation 406. The third mapping 403 may additionally comprise a sorting of the weighted recommendations and a truncation of the sorted list of weighted recommendations. This means that in each such call of the second mapping 402, the disclosed method may attempt to provide recommendations for the user given that the user is in a relatively constrained and specific mode of preferences and behaviours as captured by the persona model. When e.g. a user evolves into a preference or behaviour that has earlier been acquired for other users by the method disclosed herein, the first primary data representation with associated vector of input characterizing coefficients can be expected to be already available and applicable as a way to capture a full set of recently observed aspects of the recently observed preference or behaviour of the first user. A dynamic evolution of an input provider (such as a user in this example) as tracked in the first mapping may inherit a full vector of preference modelling as a persona model from other inputs that have earlier provided preference or behavioural data to build up the same persona model. The full persona model may be representative of a preference or behavioural “style” that may by the dynamic model be passed along from one input provider/user to another leading to collaboratively diversifying each other. Thereby the method disclosed herein provides a faster adaptation on few data points subject to an evolution in a preference or behaviour over a model in which the weight of each latent semantic factor varies more freely in fitting to the evolution of each input data. In addition to enabling faster adaptation on few data as described above, this may also lead to more diverse recommendations.

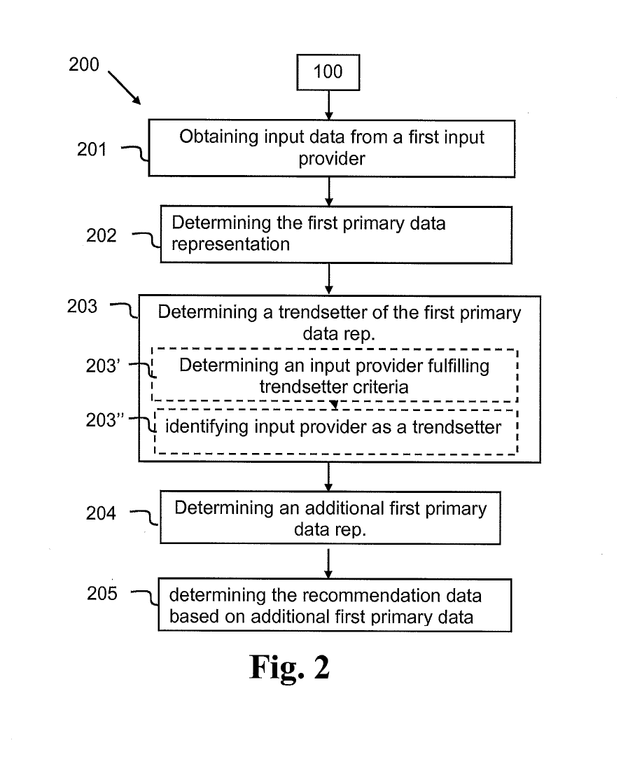

FIG. 2 shows a flow-chart illustrating an exemplary method 200 for providing a recommendation to a recipient. Method 200 comprises the steps of method 100 and obtaining 201 input data from a first input provider, the first input provider corresponding to the recipient. The method 200 comprises determining 202 the first primary data representation that the input data from the first input provider maps to. The input data from the first input provider maps to a first primary data representation by applying the first mapping. The method 200 comprises determining 203 a trendsetter of the determined first primary data representation.

Determining 203 a trendsetter of one or more first primary data representation may comprise determining 203′ one or more first primary data representation for which an input provider fulfils a trendsetter criterion, and identifying 203″ the input provider as a trendsetter.

The trendsetter criterion may comprise being a contributor of a first primary data representation such as an early contributor, i.e. an input provider having earlier provided input data that has been represented by the first primary data representation. Specifically, a trendsetter criterion may comprise being an early contributor of a vector of input characterizing coefficients indexed by a first primary data representation. An early contributor to a vector indexed by a first primary data representation may be selected amongst the first N contributors to the first primary data representation, and/or the N most active contributors to the first primary data representation. N may be dependent on the total number of contributors to a first primary data representation, such as a percentage of the total number of contributors fulfilling a criterion. An early contributor to a persona model may be selected amongst the first N contributors to the persona model, or the first N most active contributors to the persona model or according to another measure adequately identifying a trendsetter. Step 203′ involves determining which input provider has been earlier contributing and/or early contributors to a given first vector of input characterizing coefficients indexed by a first primary data representation A. Such an input provider is here referred to as “trendsetter of A” (e.g. leading users for a given first primary data representation).

The method 200 comprises determining 204 an additional first primary data representation that the trendsetter contributes to. Step 204 may involve determining which additional vector of input characterizing coefficients indexed by a given additional first primary data representation, e.g. B, models a significant part of the latest behaviour or preference of the trendsetter of A. The latest input data from an input provider that has been determined as a trendsetter of A is mapped to an additional first primary data representation B.

The method 200 comprises determining 205 the recommendation data based on the additional first primary data representation related to the trendsetter. Step 205 may comprise using an additional vector of input characterizing coefficients indexed by the additional first primary data representations B to provide recommendation data to recipients that are currently being mapped by the first mapping to first primary data representation A. The recipients that are currently being mapped by the first mapping to first primary data representation A are called “followers of A”. In one or more exemplary methods, input data can be adequately modelled as either trendsetter or follower with respect to each relevant first primary data representation. Method 200 may be a method for providing recommendation to a follower based on a trendsetter.

The method 200 may comprise introducing a bias probability or weight for said followers of A, and increasing the weight or bias probability with which followers of A are mapped to first primary data representation B, with associated first secondary data representations B.

Before an input data has itself given evidence to the processing of e.g. an initial state probability pointing to first primary data representation B, the initial state probability can e.g. be augmented/biased because one or more trendsetters of A have been observed to have:

1) previously contributed to the input characterizing coefficients relating to a first primary data representation A and
2) later “moved on” to (or currently contribute to) a first primary data representation B. For the state transition probabilities between first primary data representation A and first primary data representation B, a transition of trendsetters of A to B makes it more likely that followers of A are likely to be recommended with items relating to first primary data representation B, even before any input data providing empirical evidence for the modelling of the input data with B. Followers of A are consequently exposed to recommendations that are obtained with input characterizing coefficients relating to first primary data representation B while the followers of A may not themselves have provided empirical evidence for this interest in the input data.

The method 200 may provide thus a collaborative discovery of diversity, which emphasizes on the general diversity enabling mechanism of the disclosed technique. A user can be allocated to several first primary data representations with diverse vectors of input characterizing coefficients leading to diverse recommendations.

The method disclosed herein enables a proactive approach to the dynamic adaption accomplished in the first mapping.

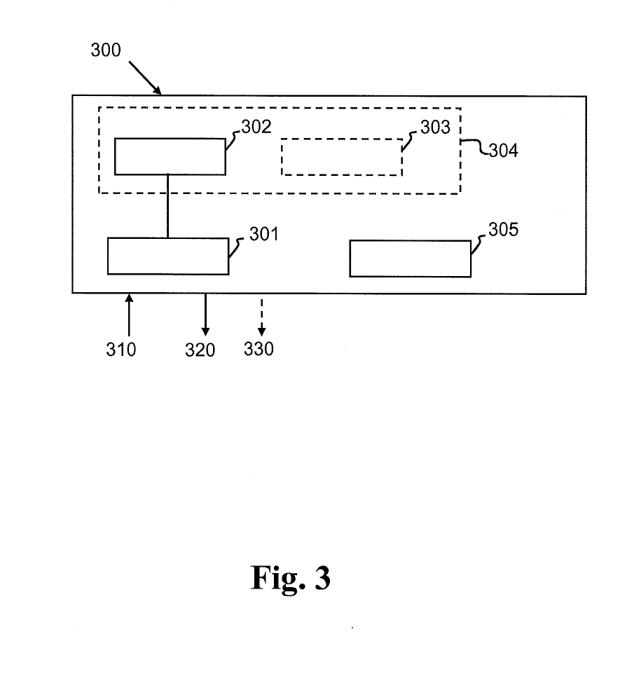

FIG. 3 illustrates an exemplary block diagram of an exemplary recommendation apparatus 300 according to the present disclosure. The apparatus 300 comprises: an interface 301 for receiving input data 310; one or more processors 302, 303 having an input connected to the interface; and a storage unit 305 for storing input data 310. The storage unit 305 may be a memory. The memory can be any memory, such as a Random Access Memory, RAM, a Read and Write Memory, RWM, and a Read Only Memory, ROM, or any combination thereof. The memory may also comprise persistent storage, which, for example, can be any single one or combination of magnetic memory, optical memory, or solid state memory or even remotely mounted memory including a cloud storage service.

The one or more processors 302, 303 may be any suitable Central Processing Unit, CPU, microcontroller, Digital Signal Processor, DSP, etc. capable of executing computer program code. The one or more processors 302, 303 may be comprised in a processing sub-system 304. The one or more processor 302, 303 may be distributed and/or connected to additional processors external to apparatus 300.

The one or more processors 302,303 are configured to apply a first mapping of the input data 310 to produce a first primary data representation. The first mapping is a non-bijective mapping. The processor 302 may perform the first mapping of the input data 310 and may provide the first primary data representation to the processor 303, or to an internal process of processor 302.

The one or more processors 302, 303 is configured to obtain a second data representation based on the first primary data representation. To obtain the second data representation, the processor 302, 303 may be configured to apply a second mapping of the first primary data representation. Processor 302 may perform the second mapping based on the first primary data representation and generate the second data representation. Alternatively, the processor 303 may perform the second mapping and provide the second data representation to processor 302. In one or more exemplary apparatus, the processor 302,303 applying the second mapping may run a collaborative filter.

The apparatus 300 is configured to determine recommendation data 320 based on the second data representation and to output the recommendation data 320. The recommendation data 320 may be provided through the interface 301. The one or more processors 302, 303 may determine recommendation data 320 based on the second data representation and the first secondary data representation.

The one or more processors 302, 303 may be further configured to determine a persona model 330 based on the first primary data representation and the second data representation. The apparatus 300 may be configured to output a persona model 330, possibly via interface 301.

The storage 305 may further store the first primary data representation, the first secondary data representation, and the second data representation. The stored data representation may be used at a later stage for further offline training of the first mapping and/or the second mapping, as well as for providing the next recommendations online, if applicable. In other words, the input data tuples are e.g. forwarded to a database in the storage unit 305 and used to train parameters of the recommendation apparatus in operations that may include offline training operations and/or calculations during online recommendation operation. This implies communication between the interface 301 receiving input data 310, the processor 302, 303 and the storage unit 305, for usage in offline training operations.

FIG. 4 illustrates a block diagram of an exemplary structure 400 for the method according to the present disclosure. Structure 400 comprises an input data 310 taken as input to a first mapping 401. The first mapping 401 outputs a first primary data representation 404 and a first secondary data representation 406. A second mapping 402 takes as input the first primary data representation 404 and outputs a second data representation 405. A third mapping 403 takes as input the first secondary data representation 406 and the second data representation 405, and outputs recommendation data 320.

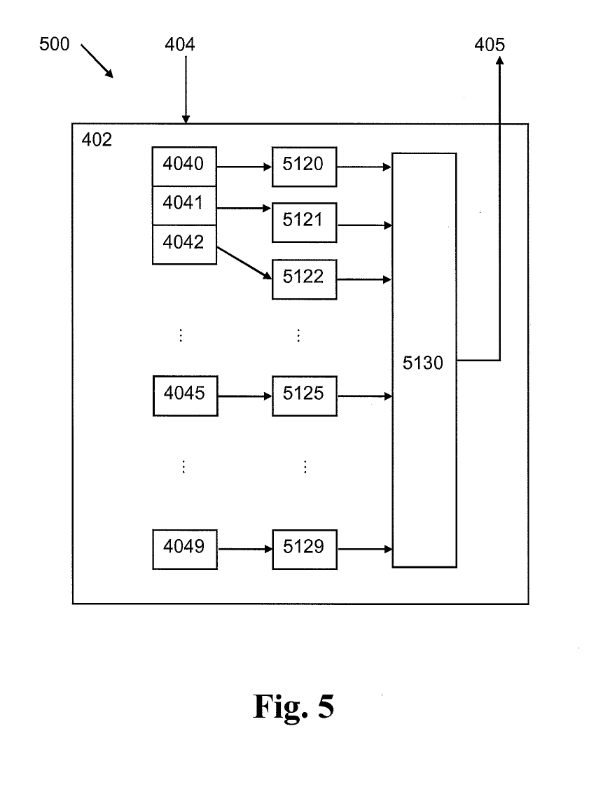

In an illustrative example of where the proposed technique is applicable, it is assumed that the first mapping comprises a Markov chain. The first primary data representation 404 is then a state identifier. The second mapping 402 takes as input the state identifier and outputs a second data representation 405. The second data representation 405 may be considered as an emission probability conditioned on a state indexed by the state identifier 404. The second mapping may be considered as outputting an emission probability mass function related to each state and each element of recommendation. Each state or cluster may be e.g. initialized as Kohonen self-organized clusters or fuzzy clusters. The input characterizing coefficients (4040, 4041 through 4045, to 4049 of FIG. 5) related to the first primary data representation 404 may be obtained by clustering or fuzzy clustering or self-organized clustering performed on the input data 310 or the input characterizing coefficients (4040, 4041 through 4045, to 4049 of FIG. 5). The second mapping parameters can then be estimated and the model including first and/or second mapping input and output can be trained using any known or to become known training method for Markov chains, such as training method for hidden Markov model. For example, an expectation-maximization method can be applied as basis for the training method. In the expectation part, the second mapping 402 is applied. In a maximization part, the second mapping 402 is trained. The third mapping 403 is then a function that uses the first secondary data representation 406 (i.e. each state probability) to weight on the second data representation 405 (i.e. emission probability related to each element of recommendation conditioned on each state) in order to generate a recommendation data 320. This way, the recommendation data 320 has a higher probability to be of interest to the recipient or an end-user of the recipient.

As an example the low-rank personalization or the neighbourhood-based collaborative filtering fit into this disclosure after adequate range shifting and normalization.

In one or more exemplary methods, the method disclosed herein is adaptive to dynamically changing recommendations. The exemplary method uses a dynamic modelling within the first mapping 401. The method may anticipate a dynamic behaviour of an (input,output)-mapping. Additionally, the method may provide proactively adapted recommendation, i.e. attempting to recommend according to an adapted behaviour or preference that has not yet emerged in the observed data. The method further provides collaborative acquisition of diversity.

In one or more exemplary methods, a step or collection of steps of the disclosed method may be repeated recursively. For example, the first mapping 401 may be repeated a number of times in order to produce a first primary data representation and/or a first secondary data representation that is provided further to e.g. a second mapping. For example, the first mapping 401 may be repeated a number of times on input data to further characterize an input provider, and/or to characterize possible elements of recommendation additional to the characterization of the input provider.

In an example where each cluster is a state in a dynamic model, methods for dynamic modelling can generally be applied according to this disclosure. The exemplary method disclosed herein introduces state transitions through discrete state transition probabilities, where for the sake of simplicity the state transition probabilities have the Markov property, i.e. the probability of transitioning from one state to another is a function only of which state it departs from. The second mapping 402 (e.g. the collaborative filtering operation) has the properties of a probability mass function for each of the states. The first mapping 401 can be accomplished by using principally any known, or to become known, method for a Markov Model, such as a hidden Markov model. However, the estimation of emission probability mass functions in the second mapping 402 is for example performed with whichever known or to become known method. The second mapping may be selected in accordance with whichever method of second mapping, such as a method for a collaborative filter that fits a set that complies with the equivalence structure given in FIG. 5 of this disclosure.

FIG. 5 illustrates a block diagram of an exemplary second mapping of the method according to this disclosure. FIG. 5 provides a generic equivalence structure for the second mapping 402, such as a collaborative filter. The second mapping 402 takes as input a first primary data representation 404. The second mapping 402 comprises a second primary mapping parameter that is the first primary data representation 404. The second mapping 402 further comprises a second secondary mapping parameter which is a vector of input characterizing coefficient 4040, 4041, . . . , 4049; a second tertiary mapping parameter which is a set of output characterizing functions 5120, 5121, . . . 5129. The second mapping 402 comprises an aggregation function 5130 that outputs a second data representation 405.

In an example, it is assumed that the second mapping is a low-rank personalization model initially applied to input data from a user. A low-rank personalization model provides a low-rank mapping between users and items, providing estimated ratings e.g. as:

rᵤᵢ=bᵤᵢ+pᵤ^{T}*qᵢ

where rᵤᵢ is the estimated rating for user u of item i, bᵤᵢ is a trained bias element for that rating and pᵤ is a vector of personalization factors for user u and qᵢ is a vector of property factors for item i.

The input data is defined as a value u indexing a certain user, and a value i indexing a certain item for which an estimate of its user rating is sought. An identifier of the pᵤ vector is the first primary data representation in this example. The input characterizing coefficient 4040 is the first element in the vector pᵤ, the input characterizing coefficient 4041 is the next element, etc. until 4049 which is the last element. The output characterizing function 5120 is e.g. a function that multiplies its input with the first element of the qᵢ vector, 5121 multiplies with the second element of the qᵢ vector etc. until 5129 which is multiplied with the last element in the qᵢ vector. Finally the aggregation function 5130 for example sums these products together and eventually adds to it a bias term bᵤᵢ. Subsequently, the first mapping may be trained on e.g. the resulting input characterizing coefficients 4040 to 4049 where after the low-rank personalization model is re-applied on the first primary data representations, which corresponds to replacing input data from users with first primary data representations. The output of the aggregation function 5130 is a second data representation which may be considered as a mapping of items to users. A low-rank personalization may be applied as a second mapping of the disclosed method also when the disclosed method is trained as a probabilistic model such as a Markov chain, or a hidden Markov model.

The input characterizing coefficients may be time varying. The input characterizing coefficients may comprise adequately scaled similarity measures on the historic input data for a neighbourhood in a neighbourhood-based method for the second mapping 402.

The equivalence structure illustrated in FIG. 5 is applicable to a low-rank personalization model, a probabilistic latent semantic model, a Markov model, a neighborhood-based model, a regression-based latent factor model, and/or a hypergraph method.

In one or more exemplary methods, the second mapping may first be trained during an offline training operation. The training of the second mapping 402 may be performed directly with the input data 310 that is directed unaltered to the second mapping. Subsequently, the values in 4040, 4041 through 4045, to 4049 are for each such input data used as a vector representation of that input data u.

In one or more exemplary methods where the second mapping comprises any collaborative filter, the second mapping 404 is exemplified by the principal structure of FIG. 5. In such exemplary method, for each input 404, the second mapping involves a calculation of a probability mass function or any other values that may be considered as a probability mass function after adequate shifting and scaling with values output in 405 for each of a set of possible outputs. The recommendation may be made in a third mapping 403 by sorting the probabilities in 405 on elements conditioned on states identified by 404. For example, elements with the highest probability that has not yet been recommended to or otherwise consumed by the recipient are output in 320 by the third mapping as recommendation to the recipient.

In an illustrative example of where the second mapping is collaborative filtering such that the output values does not formally meet the requirements for being a probability mass function, the output values can be jointly shifted into the positive range and further normalized to sum to 1.0 such as to meet these formal requirements without altering their function in terms of enabling a sorting of potential elements to recommend. This applies both where the collaborative filter is initially intended and designed for operating with explicit scores and where the collaborative filter is initially intended for operation on behavioural observation data like occurrence counts.

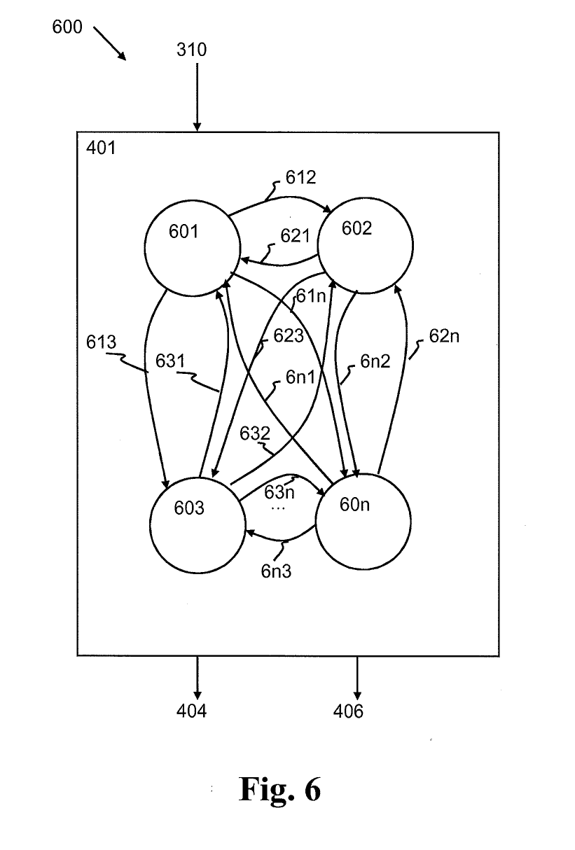

FIG. 6 illustrates a block diagram of an exemplary first mapping of the method according to the disclosure. FIG. 6 shows the overall processing block 401 of the first mapping. Block 401 is an example of the internal dynamics for the first mapping. The first mapping 401 take as input the input data 310. The output of the first mapping 401 is a first primary data representation 404, and a first secondary data representation 406.

To relate this to the rest of the method disclosed herein, the first primary data representation 404 is to be forwarded to a second mapping exemplified as 402 in FIG. 4. And the first secondary data representation 406 is to be provided from the first mapping 401 to a third mapping 403 in FIG. 4.

In FIG. 6, the circles 601, . . . , 60n are used to designate states from 1 to n (with nεZ) and the arrows such as 612 are used to designate state transitions, such as a transition from state 601 to state 602 for arrow 612. The first primary data representation 404 is an identifier indexing a state, i.e. for example an identifier for state 601. Each state 601, . . . , 60n may be representative of a persona model.

The first mapping 401 in FIG. 6 is a Markov chain. Input data 310 is mapped to one or more states 601 to 60n of a Markov chain depending on state probabilities and state transition probabilities. In an example where online recommendation are provided to a user on items, the first mapping 401 calculates e.g. the dynamically changing probabilities of each of states being currently active in the user preferences or behaviour and passes each of them (or a top-M most likely part of them) to the second mapping. In this example, the user is captured by a state given that the user is in a relatively constrained and specific mode of preferences and behaviours.

This disclosure provides a training operation of the disclosed method. Training refers to exercising the method, including exercising the first mapping and the second mapping based on input data and updating one or more parameters (e.g. coefficients) and one or more outputs of the first mapping, of the second mapping and of the method. A training operation of the disclosed method may comprise recursively repeating any of the steps or any collection of steps of the method.

According to this disclosure, the method may further comprise estimating a first secondary data representation relating to each first primary data representation. The first mapping and the second mapping together may be considered as a hidden Markov model, where the first primary data representation is an identifier of a hidden state of the hidden Markov model. Additionally or alternatively, the method may comprise replacing in a hidden Markov model applying one or more emission probabilities by applying the second mapping. Additionally or alternatively, the method may comprise replacing in a hidden Markov model estimating one or more emission probabilities by a training operation of the second mapping.

In an illustrative example of a training operation for the disclosed method, the initialization for the training operation can be e.g. obtained from the method disclosed above using a combination of a Kohonen self-organized map and a fuzzy clustering, and where the state transitions may be then initially seeded with a small transition probability connecting all states and a remaining, close-to-one, self-transition for each state. The numbers to choose depend on the concrete dataset, the resulting initiation point and the machine precision. With an example of 1000 states, the initial state probabilities for an input can e.g. be initialized to 0.9001 for the state that the input is initially clustered to (if only one) and to e.g. 0.0001 for all other states for this input. Similarly, the self-transition probability (i.e. from a state to itself) can be initialized to e.g. 0.9001 and all other state transitions can be initialized to e.g. 0.0001.

A training operation of the disclosed method may further comprise clustering vectors of input characterizing coefficients relating to each first primary data representation during a training iteration. Clustering may be performed for converging towards an adequate set of first primary data representations. Clustering may be performed at various occurrences, periodically or upon a triggering event. Clustering vectors of input characterizing coefficients relating to each first primary data representation during the training iteration may be performed using an unsupervised training step, such as e.g. a Kohonen Self-Organized Feature Map. A Kohonen Self-Organized Feature Map seeks to find the topology of input characterizing coefficient vectors by clustering vectors that are similar closer and vectors that fit less well away (often referred to as the Mexican Hat function in connection with Self-Organized Feature Maps). In clustering vectors of input characterizing coefficients, input characterizing vectors relating to the input data are used as training data. This has the effect that states in the first mapping (characterized in vectors of input characterizing coefficients) that fit the input data (characterized in their initial characterizing vectors) are attracted, and the ones that fits the best are attracted the most, while the states of the first mapping that fit the worst are detracted. The disclosed method combining a first non-bijective mapping and a second mapping “liberates” each input data to the underlying second mapping from simply seeking to capture as well as possible a single recipient and its relations to elements for recommendation. In one or more exemplary methods, an offline training of the disclosed method may involve an “inter-play” between the usage of the unsupervised attraction/detraction based training of first primary data representations and the disclosed training technique. The disclosed training technique for the disclosed method comprises training based on conventional hidden Markov models wherein a conventional estimation of emission probabilities is replaced by a training of the second mapping 402. As an example, each first primary data representation (e.g. state or a state identifier in the Markov chain) can initially be set to represent one <u>, or a set of closely related <u>'s found through an initial pruning process. Subsequently, iterations are run in which both unsupervised attraction/detraction of input characterizing coefficients and hidden Markov model like training are applied, wherein the hidden Markov model is modified according to this disclosure to replace the estimation of emission probabilities by a training of the second mapping 402. This way, the resulting vectors of input characterizing coefficients conceptually seek to find a compromise between topologically describing the space of observed <r>'s of the set of <u>'s and simultaneously capturing each <u> or closely related group of <u>'s which then gradually evolves into dynamically capturing the states in the dynamic trajectory of <u>'s through different first primary data representations or states. This captures the topological space of overall <r>'s relating to <u>'s. The attraction/detraction weighting may be a function of the equivalent probability mass function that the second mapping 402 input-output relation represents. Alternatively or additionally, the attraction/detraction weighting may now further be a function of a model based probability of the first primary data representation including memory through the dynamic Markov chain model according to this disclosure. Especially for a small set of input data, adequate combination of the disclosed method is to be observed.

In an illustrative example of a tracking algorithm in the disclosed method, the first mapping as a Markov chain (once trained in an offline training operation) may use any known or to become known method based on a Markov model (such as a method for hidden Markov modelling) for tracking dynamic changes in mapping parameters. Tracking dynamic changes in mapping parameters may comprise estimating and updating state probabilities during online recommendation operation according to this disclosure. For tracking dynamic changes, the second mapping (e.g. a collaborative filter) provides as output an emission probability mass function conditioned on e.g. a state of a hidden Markov model. Depending on the input data, the method disclosed herein may select a suited combination of groupings of input data and clusters for which initial state probabilities and state transitions are jointly found. For example, for the provisioning of recommendations for users, behaviour or preference data is assumed to be relating e.g. 1,000,000 different users with 10,000 different items. The first mapping from the input data produces e.g. 1,000 different clusters, which initially become states in a hidden Markov model, and where the mapping from user to states is e.g. then initially replaced by 1,000,000 different initial state probability vectors, each with 1,000 elements. The initial state probability vectors are then updated together with e.g. one single state-transition matrix (i.e. a 1,000×1,000 matrix) on the full input data from 1,000,000 input identities. With training of hidden Markov models, careful splitting and pruning strategies may be considered along the acquisition-learning trajectory.

In an empiric scenario of everyday choice, human choice integrates only few factors at a time. Therefore the disclosed method may further use of sparse modelling in optimization of the second mapping to e.g. reduce the number of elements of recommendation that end up rendered to an end user.

In one or more exemplary method and apparatus, the first mapping and/or the second mapping may be optimized using a sparse optimization method. Sparsity may refer to the fact that a vector of input characterizing coefficients, 4040 to 4049 and/or output characterizing functions 5120 to 5129 in the structure of FIG. 5 have a large proportion of its coefficients and/or functions that has become zero through a training method.

The non-bijective first mapping 401 may provide a split between persona and user. Additionally, using sparse modelling in connection with persona modelling in the second mapping may provide a persona model that “embodies” the user when desiring a particular combination of experiences. The sparse representation of the persona specific latent factors or low-rank approximation coefficients, i.e. the input characterizing coefficients, may be more efficient from a human cognition perspective than an entire set of preferences, or behaviours or rates reduced to only one vector of input characterizing coefficients. Moreover, an enabling factor for a more efficient use of sparse learning methods within a second mapping (such as a collaborative filter) may lead to faster adaption and faster performance uptake especially in a start-up phase following the introduction of a new user or item where input data is initially very scarce. The first mapping may apply sparsity in the dynamic modelling as follows. In an example, it is assumed that the input data is from users. A user is mapped to one of many first data primary representations in the first mapping. The set of users may be in the range of millions and the number of first data primary representations may be in the range of thousands. However, a first data primary representation is actually able to capture a full set of input data for the underlying second mapping, such as a full vector of latent semantic factors. Thus, a single user may in practice be very well modelled with just a few such first data primary representations because even four or five or ten or hundred first primary data representations is a remarkable increase in modelling freedom and dynamic change freedom for the modelling of each user when compared to e.g. a single vector of latent semantic factors. Therefore, the first mapping may be optimized by the usage of sparse techniques within training of the dynamic model, such as sparse training of hidden Markov models. According the present disclosure, the second mapping may apply sparse optimization. For example, the general estimation of emission probabilities of a general hidden Markov model of the second mapping may be optimized with sparse optimization. In both cases of sparse modelling, i.e. in the first mapping and in the second mapping, the sparse modelling may be expected to provide even faster and more robust adaptation on fewer data.

1. A method performed in a recommendation apparatus for providing an element of recommendation to a recipient, the recommendation apparatus comprising an interface and one or more processors, the method comprising:
obtaining input data in form of one or more tuples via the interface;
using the one or more processors to apply a first mapping to the input data to produce a first primary data representation, the first mapping being a non-bijective mapping, the first primary data representation identifying a cluster or a state based on the one or more tuples;
providing the first primary data representation;
using the one or more processors to obtain a second data representation based on the first primary data representation, the second data representation being indicative of a set of elements with associated estimates;
using the one or more processors to determine recommendation data for the recipient based on the second data representation, the recommendation data comprising the element of recommendation;
outputting the recommendation data to the recipient via the interface.

2. Method according to claim 1 further comprising applying a second mapping to the first primary data representation to produce the second data representation; and providing the second data representation.

3. Method according to claim 2, wherein the second mapping comprises collaborative filtering.

4. Method according to claim 2, wherein the second mapping comprises input characterizing coefficients, a set of output characterizing functions, and an aggregation function.

5. Method according to claim 2, further comprising applying the second mapping to a plurality of first primary data representations.

6. Method according to claim 2, wherein the second mapping comprises a second primary mapping parameter, and wherein the second primary mapping parameter is representative of the first primary data representation.

7. Method according to claim 1, wherein the first mapping comprises a clustering method and/or a Markov chain, the clustering method comprising a fuzzy clustering method, and/or a self-organized clustering method.

8. Method according to claim 1, wherein applying the first mapping comprises producing a first secondary data representation, and wherein determining recommendation data for the recipient based on the second data representation comprises applying a third mapping to the first secondary data representation and the second data representation.

9. Method according to claim 8, wherein the first primary data representation comprises an identifier of one or more states including a first state in a Markov chain; the first secondary data representation comprises one or more state probabilities including a state probability of the first state; and the second data representation comprises an emission probability related to the first primary data representation.

10. Method according to claim 1, the method comprising:
obtaining input data from a first input provider, the first input provider corresponding to the recipient;
determining the first primary data representation that the input data from the first input provider maps to;
determining a trendsetter for the determined first primary data representation;
determining an additional first primary data representation that the trendsetter contributes to; and
determining the recommendation data based on the additional first primary data representation related to the trendsetter.

11. Method according to claim 10, wherein determining a trendsetter of one or more first primary data representation comprises:
determining one or more first primary data representations for which an input provider fulfils a trendsetter criterion;
identifying the input provider as a trendsetter for the one or more first primary data representations fulfilling the trendsetter criterion.

12. Method according to claim 1, wherein the first mapping and/or the second mapping is optimized using a sparse optimization method.

13. Method according to claim 1, the method comprising
determining a persona model based on the first primary data representation and the second data representation; and
outputting the persona model.

14. A recommendation apparatus, the recommendation apparatus comprising:
an interface for receiving input data, the input data being in form of one or more tuples;
one or more processors having an input connected to the interface;
a storage unit for storing input data;
wherein the one or more processors are configured to apply a first mapping of the input data to produce a first primary data representation, the first mapping being a non-bijective mapping, the first primary data representation identifying a cluster or a state based on the one or more tuples; and wherein the one or more processors are configured to obtain a second data representation based on the first primary data representation, the second data representation being indicative of a set of elements with associated estimates; and
wherein the apparatus is configured to determine recommendation data based on the second data representation, the recommendation data comprising the element of recommendation; and
wherein the apparatus is configured to output the recommendation data.

15. Recommendation apparatus according to claim 14, wherein the one or more processors is further configured to apply a second mapping of the first primary data representation to obtain the second data representation.

16. A computer program comprising computer readable code which, when run on a processor, causes an apparatus to perform the method as claimed in claim 1.
